(19) United States
(12) Patent Application Publication
(10) Pub. No.: US 2010/0060980 A1
(43) Pub. Date: Mar. 11, 2010

(54) DEVICE FOR INTRODUCING AN OPTICAL ELEMENT INTO THE OBSERVATION BEAM PATH OF A LIGHT MICROSCOPE

(75) Inventor: Heinz Suhner, Rebstein (CH)

Correspondence Address: ALEXANDER R SCHLEE;SCHLEE IP INTERNATIONAL P.C., 3770 HIGHLAND AVENUE, SUITE 203, MANHATTAN BEACH, CA, 90266, US

(73) Assignee: LEICA MICROSYSTEMS (SCHWEIZ) AG, Heerbrugg (CH)

(21) Appl. No.: 12/551,046

(22) Filed: Aug. 31, 2009

(30) Foreign Application Priority Data
Sep. 5, 2008 (DE) 10 2008 045 826.0

(51) Int. Cl. G02B 21/00; G02B 21/22

(52) U.S. Cl. 359/381; 359/376

(57) ABSTRACT

A device is described for placing at least one optical element in an observation beam path of a light microscope. This device comprises a rotatably mounted support for the at least one optical element and an electric drive for rotating the support. By rotating the rotatably mounted support the at least one optical element is place in or removed from the observation beam path. The support and the drive are coupled by a stepping gear mechanism converting a continuous movement of the drive into a stepwise movement of the support between defined working positions, the working positions being selected such that the optical element assumes a defined position with respect to the observation beam path.

### CROSS-REFERENCE TO RELATED APPLICATION

This application claims the priority of the German patent application DE 102008045826.0 having a filing date of Sep. 5, 2008. The entire content of this prior German patent application DE 102008045826.0 is herewith incorporated by reference.

### BACKGROUND OF THE INVENTION

The invention belongs to the field of light microscopy and relates to improvements, in particular for surgical microscopes and other stereomicroscopes. It relates to a device for optionally introducing at least one optical element into an observation beam path of a light microscope which can, in particular, be used as a magnification changer for setting discrete magnifications.

It is known to provide in the observation beam path of a light microscope a magnification changer which enables switching over between discrete magnification stages. Alternatively or in addition, a zoom system can be present which has lenses which can be adjusted with respect to one another in the direction of the optical axes and enables a continuous change in the magnification.

A discrete magnification changer comprises a rotatable support for at least one imaging system, in particular for lens pairs which are arranged in the manner of a Galilei telescope and can be introduced optionally into the observation beam path, the magnification being determined by the rotary position of the support. By way of example, it is introduced into the parallel beam path of the microscope, for example also in addition to a zoom system mentioned above. In the case of stereomicroscopes having two mutually separate observation beam paths, at least one pair of imaging systems is present of which in each case one is introduced into in each case one observation beam path by rotating the support. Also known instead of imaging systems is the selective introduction of other optical elements, for example of beam interrupters or filters.

In the case of conventional light microscopes, in particular in the case of surgical microscopes as well, the magnification is set manually by rotating the support, for example via a handle, such that the support assumes various working positions prescribed by a suitable mechanism. By way of example, in these working positions, the optical axis of the imaging system corresponds to that of the observation beam path. By way of example, DE-OS 1 284 117 (CH 470 677) discloses a magnification changer for a stereomicroscope with two objectives, in the case of which, on the one hand, there are present a manually rotatable first support with various interchangeable objectives and, on the other hand, a rotatable second support with a plurality of Galilei telescopes. The first and second supports are coupled to one another mechanically by means of only partly circumferentially toothed pinions or by means of a Maltese cross mechanism. As a result of this, a full revolution of the first support leads to a change of the second support between two working positions such that it is possible overall to switch between discrete magnification stages prescribed by the combination of interchangeable objective and Galilei telescope by rotation at a single handle.

Particularly in the case of surgical microscopes, however, it is disadvantageous when the operator needs to set the magnification by hand or must make a change during an operation by rotating a drive wheel or handle. The point is that the operator should have both hands free and not have to interrupt his work. Moreover, the change in magnification should be performed quickly and without applying force externally, which can lead, for example, to an inadvertent displacement of the microscope.

In addition to the manual adjustment, it is also known to set the rotary position of the support with the aid of a suitable drive: DE-A 103 24 238 proposes automatically acquiring and storing the rotary position of the support. The stored information serves for reproducing the magnification set, this being done by bringing the support into the appropriate working position again by means of an actuator.

DE-A 103 36 890 likewise mentions an electric drive of a change wheel for optical elements, which are designed there as filters, diaphragms or beam interrupters. The drive itself is not described in more detail in this case.

An actuator as in the case of DE-A 103 24 238, for example a stepping motor, must have a high positioning accuracy when it is intended to be used to introduce an imaging system into a beam path of a microscope; such stepping motors are expensive. Moreover, stepping motors are precise only as long as they are switched on, that is to say energized. This is particularly undesirable in conjuction with surgical microscopes. Moreover, actuators require a suitable controller in order to be able to hold and/or reproduce the current position. The result of this is that a magnification changer with storable and automatically reproducible magnification on the basis of an actuator such as described in DE-A 103 24 238 is complicated and expensive.

### SUMMARY OF THE INVENTION

It is therefore the object of the invention to make available a device for optionally introducing at least one optical element into an observation beam path of a light microscope, in particular a magnification changer, which device in a simple and precise way enables a change in magnification which is not carried out manually.

This is achieved by a device for placing at least one optical element in an observation beam path of a light microscope, comprising: a rotatably mounted support for the at least one optical element; and an electric drive for rotating the support, wherein by rotating the rotatably mounted support the at least one optical element is place in or removed from the observation beam path, and wherein the support and the drive are coupled by a stepping gear mechanism converting a continuous movement of the drive into a stepwise movement of the support between defined working positions, the working positions being selected such that the at least one optical element assumes a defined position with respect to the observation beam path.

The inventive device comprises in a way known per se a support, rotatably mounted on a holder, for example, for the at least one optical element, and an electric drive for rotating the support, it being possible for the at least one optical element to be introduced into or removed from the observation beam path by rotating the support According to the invention, the support and the drive are coupled mechanically by a stepping mechanism with the aid of which a uniform movement on the part of the drive is converted into a stepwise movement of the support between defined working positions. The working positions are selected such that the at least one optical element assumes a defined position with reference to the observation beam path.

The at least one optical element is preferably an imaging system which serves for setting different magnifications. In its operating position (working position), its optical axis preferably corresponds to the optical axis of the corresponding observation beam path. However, there can also be other elements, for example a beam interrupter, a mirror or an electro-optical component, in the case of which the accurate correspondence of the axes is not so critical.

The stepping mechanism enables the use of a simple electric motor, working continuously in principle, without a complicated controller, for example only with a switching-on/switchoff mechanism built for precisely introducing optical elements into the observation beam path of a light microscope, in particular for setting different magnification stages. Owing to the stepping mechanism, which fundamentally permits only certain discrete messaging positions of the support, it is possible to dispense with a control unit which detects the working position assumed, stores it and reproduces it again accurately when appropriately commanded. It is likewise possible to dispense with an actuator which carries out such a reproduction with the required accuracy.

In order for the support to be brought in each case only from one working position into the next, a control device is preferably present which has a particularly manually operable switching-on elements, for example a foot switch, for activating the drive. By way of example, the switching-on element generates a switching-on signal or a corresponding control command with the aid of which the motor is started up. The control device further comprises a switching element with the aid of which a switchoff signal is generated for shutting down the drive as soon as the support has assumed one of the working positions. By way of example, the switching element comprises a light barrier, an electrical or inductive switch or another sensor which generates the switchoff signal when a working position is reached, for example in the case of a drive shaft of the drive by a predetermined absolute value. A stepwise switchover between the various working positions is thereby achieved in a simple way. The direction of rotation of the support can preferably be influenced by means of two switching positions, for example in order to switch over to a higher or lower magnification stage.

The drive and the mechanical stepping mechanism need not be highly precise, and can therefore be of simpler and less expensive design when, in accordance with an advantageous development of the invention, an additional latching mechanism is provided which serves for retaining the support in one of the working positions. By way of example, the latching mechanism comprises at least one stationary latching element, for example a resiliantly mounted latching ball, and at least one latching element, for example a slot, connected to and moving with the support. These elements are dimensioned such that the latching force for switching over between two working positions can be overcome by the drive, but that the latching position is automatically assumed when the drive is switched off in a certain region around the working/latching position. This delivers a very exact positioning which is improved once again by comparison with the positioning effected solely by the stepping mechanism. The transfer function of the mechanism therefore need not be exact, because the accurate positioning is taken over by the latching mechanism and not by the mechanism itself.

In order to amplify this effect, the stepping mechanism prescribes the working position preferably only within a certain angular range, that is to say activates only a prepositioning with a desired inaccuracy. The exact working position is then set and fixed by the latching mechanism in a passive way. Very high accuracies are hereby achieved in conjunction with a simple design.

If the inventive device is designed for a stereomicroscope with two mutually separated observation beam paths, the support preferably has in each case pairs of optical elements which are preferably offset from one another by an appropriate absolute value and can be introduced into the respective beam path synchronously with one another. Of course, it is also possible to arrange the corresponding elements on separate supports, or to introduce the at least one optical element into only one of the beam paths. It is likewise possible to use a pivotable or linearly displaceable support instead of a rotatable support.

In a preferred development of the invention, which is described in more detail below with reference to the figures, the stepping mechanism is a Maltese cross mechanism having a star wheel, assigned to the support, with inner or outer slots, and having a drive wheel, assigned to the drive, with at least one driver element. In a particularly simple way, the Maltese cross mechanism enables the conversion of the continuous movement of the drive into a discrete positional change of the support. In the case of an outer Maltese cross mechanism, that is to say one having slots introduced into the outer edge of the star wheel, the retention of the support in the working positions can be achieved in a simple way by means of a blocking element on the drive wheel which cooperates with the star wheel. However, it is also possible to use an inner Maltese cross mechanism in the case of which the slots run in the shape of a star from an inner cutout. Since this results without further measures in no blocking of the current working position against further rotation, the support is retained in the current working position by the additional latching mechanism.

### BRIEF DESCRIPTION OF THE DRAWINGS

Examples of the invention are illustrated in the figures, in which, purely diagrammatically:

FIG. 1 shows an overview illustration of a stereomicroscope with an inventive changing device;

FIGS. 2a & b show various views of a changing device with a Maltese cross mechanism;

FIG. 3 shows the changing device in accordance with FIGS. 2a & b with a latching mechanism for fixing the working position;

FIGS. 4a-d show various views of the drive-side part of the changing device in accordance with FIGS. 2a & b.

### DETAILED DESCRIPTION OF THE DRAWINGS

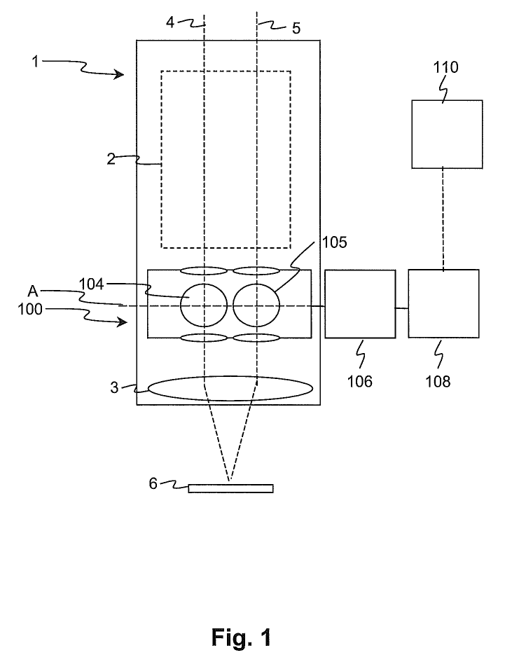

FIG. 1 shows purely diagrammatically a stereomicroscope 1 with two mutually separated observation beam paths 4, 5 for the stereoscopic observation of an object 6. The light coming from the object 6 passes through a common (main) objective 3, and is imaged into the eyes of the observer with the aid of an optically imaging system 2 (not illustrated in more detail) which as a rule comprises at least one tube lens system and eyepieces as well as, if appropriate, also a zoom system for continuously setting the magnification. An inventive changing device 100 serves the purpose of optionally introducing one or more optical elements 104, 105 into the stereoscopic beam paths 4, 5, and removing them therefrom. The optical elements 104, 105 are arranged for this purpose on a support 102 which can be rotated or pivoted such that the beam paths 4, 5 optionally traverse or do not traverse the optical elements 104, 105. The optically active elements of the device 100 can be arranged between the objective 3 and the optical system 2, or part of the optical system 2.

The changing device 100 is presently illustrated as a magnification changer which comprises per beam path 4, 5 pairs of lenses arranged in the manner of a Galilei telescope. The rotatable support 102 has the form of a drum with a rotating axis A which is here horizontal or runs perpendicular to the optical the axis of the microscope. The optical elements 104, 105 are arranged on the lateral surface of the drum, the elements 104, 105 assigned to the respective beam paths 4, 5 being spaced apart from one another in the direction of the axis A.

It is also possible for the optical elements 104, 105 to be arranged on the end faces of the drum 102, and for the rotation axis A to run vertically or parallel to the optical axis of the microscope. As described in DE A 103 36 890, the support 102 could likewise be designed as one or two wheels the plane of which runs perpendicular to the optical axis of the microscope 1 or its beam paths 4, 5.

Instead of lenses, the optical elements 104, 105 can also be non-imaging elements, for example filters, beam interrupters, mirrors or electro-optical components. The latter can be, for example, transparent liquid crystal displays (LCDs) which can be driven such that various patterns of transparent or opaque surfaces are formed which serve, for example, to simulate diaphragms of variable aperture. Moreover, it is possible for elements to be involved which can be used to reflect information in or out. It goes without saying that these elements can also act only on one of the beam paths, or that an appropriate changing device 100 can also be used for light microscopes with only one observation beam path.

In addition to the support 102, the changing device 100 comprises an electric drive 108, for example a conventional electric motor, as well as a stepping mechanism 106. The stepping mechanism 106 serves to transmit the movement of the drive shaft 109 of the drive 108 to the support, or to convert the continuous rotary movement of the drive shaft 109 into a stepwise rotary movement of the support 102 between various working positions in discrete angular positions, for example six working positions at a spacing of 60°. A control device 110 to be operated by the user, for example a hand/foot switch, serves to initiate a change in the working position by virtue of the fact that the motor 108 is switched on and switched off again after the new working position is reached. If appropriate, the switch can have two switching positions for the purpose of raising or lowering the magnification, and these influence the direction of rotation of the drive shaft 109 and thus also of the drum 102 about the axis A.

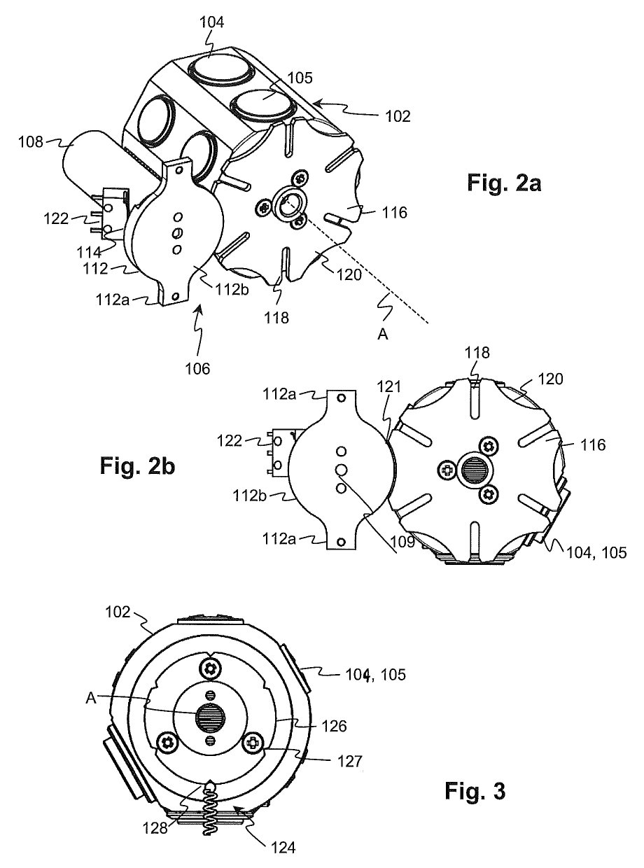

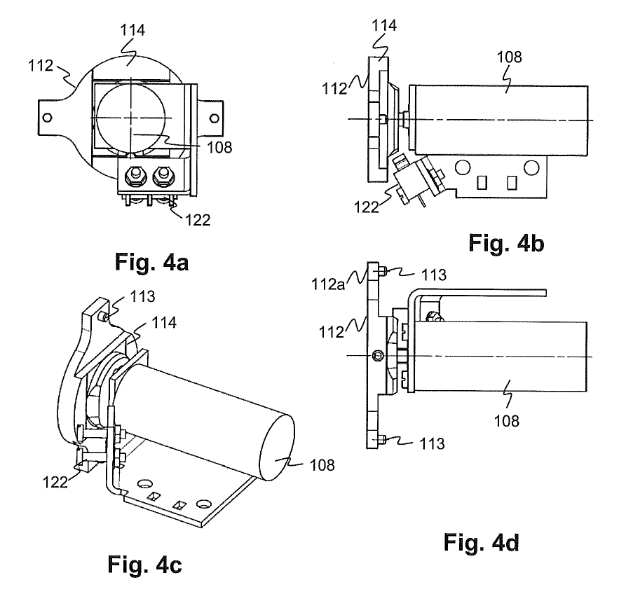

FIGS. 2a & b show various views of a changing device 100 having a Maltese cross mechanism as stepping mechanism 106. The drive-side part thereof is illustrated in more detail in FIGS. 4a-d in various views. FIG. 3 shows the latching mechanism 124 which is located at that end of the drum-like support 102 that is averted from the drive 108.

The Maltese cross mechanism 106 comprises a drive wheel 112 which is coupled (here fixedly connected) to the drive 108 or the drive shaft 109 thereof. The drive wheel 112 has the form of a circular disc with two radially protruding projections 112a and, therebetween, two boundary surfaces 112b resembling circular segments. The projections respectively carry a drive pin 113 which engages in the slots 118 of a star wheel connected fixedly to the support 102, drives said star wheel during the engagement but otherwise does not influence it. The outer surface of the star wheel 116 between the slots in the region denoted by 120 has a concave shape which corresponds approximately to the inverse of the boundary surfaces 112b resembling circular segments. The latter boundary surfaces therefore act as blocking elements 114 and retain the rotary position of the star wheel 116 until one of the driver pins 113 engages anew. Six slots 118 at 60° spacings and two driver pins 113 spaced apart by 180° are present in this case; it is also possible for other subdivisions to be selected. Half a revolution of the drive shaft 109 therefore leads to a change from one working position into the next of in total six working positions.

When a new working position is reached, this is established by means of a switching element 122 which then generates a switchoff signal for the motor 108, for example interrupts the power supply. The switching element 122 is, for example, a microswitch, a light barrier, a proximity switch (inductive/capacitive) or some other suitable sensor which, for example reacts to the passing by of the driver pin 113 or of another element on the drive wheel 112 or the star wheel 116. The motor 108 is therefore energized only when there is a real need for a rotary movement.

As indicated in FIG. 2b, a small gap 121 of, for example, a few tenths of a millimetre is located between the blocking element 114 and the corresponding mating elements 120 (concavely curved outer edges of the star wheel between the slots 118). It follows that the rotary position of the star wheel 116 is not exact in the inactive positions of the drive wheel 112, that is to say those without transmission of force to the star wheel 116, but is prescribed or fixed by the drive wheel 112 only with a certain inaccuracy of, for example, 2-3°. According to the invention, the accurate positioning is preferably performed by an additional latching mechanism 124 which is illustrated in FIG. 3. The play or the gap 121 between the elements 114 and 120 has the advantage in combination with the latching mechanism 124 that wear is reduced and that it is possible to achieve a more accurate positioning than solely by means of the stepping mechanism 106, or that the drive must be less exact as such together with the coupling (stepping mechanism 106).

The latching mechanism 124 shown in FIG. 3 comprises a latching disk 126 which is permanently connected to the support 102 and has on the circumference a number, corresponding to the number of working positions, of slots 127 with a V-shaped profile. The latching disk 126 is fitted on that end of the support 102 that is averted from the drive and is coaxial with the rotational axis A of the support 102. A stationary latching element 128, here a resiliently mounted ball, cooperates with the slots 127 and fixes the support 102 with the requisite accuracy in one of the working positions which has been preset by the drive 108 and the stepping mechanism 106. The shape of the profile is selected such that the inaccuracy of the prepositioning of in this case 2-3°, for example, is compensated, whereas the latching by the drive can be overcome again.

### LIST OF REFERENCE NUMERALS

1 Stereomicroscope

2 Optically imaging system of the microscope

3 Main objective

4, 5 Stereoscopic observation beam paths

6 Object

100 Changing device

102 Support

104, 105 Optical elements

106 Stepping mechanism

108 Drive

109 Drive shaft

110 Control device

112 Drive wheel

112a Projection

112b Region resembling a circular segment

113 Driver pin

114 Blocking element

116 Star wheel

118 Slot

120 Mating element for the blocking element

121 Gap/play

122 Switching element

124 Latching mechanism

126 Latching disk

127 Slot in latching disk

128 Latching element

What is claimed is:

1. A device for placing at least one optical element in an observation beam path of a light microscope, comprising:
a rotatably mounted support for the at least one optical element; and
an electric drive for rotating the support, wherein
by rotating the rotatably mounted support the at least one optical element is placed in or removed from the observation beam path, and wherein
the support and the drive are coupled by a stepping gear mechanism converting a continuous movement of the drive into a stepwise movement of the support between defined working positions, the working positions being selected such that the at least one optical element assumes a defined position with respect to the observation beam path.

2. The device according to claim 1, wherein the stepping gear mechanism is a Geneva drive mechanism comprising:
a star wheel interacting with the support and having slots, and
a drive wheel interacting with the drive and having at least one actuator element.

3. The device according to claim 2, wherein the drive wheel comprises at least one blocking element interacting with matching counter elements on the star wheel at least for prepositioning the support in one of the working positions.

4. The device according to claim 3, wherein the at least one blocking element and the counter elements are designed to match each other and are spaced apart from one another by a gap such that the rotary position of the support is fixed by these elements within a predetermined angle range allowing play.

5. The device according to claim 1, further comprising a latching mechanism for retaining the support in one of the working positions, said latching mechanism having a stationary first latching element and at least one second latching element that is connected to and therefore moves with the support.

6. The device according to claim 1, further comprising a control device having a manually operable switch for activating the drive and a switching element for generating a switchoff signal for stopping the drive when a working position of the support is reached.

7. The device according to claim 6, wherein the switching element comprises at least one of a photoelectric switch, an electrical switch, an inductive switch, and a sensor.

8. The device according to claim 1, wherein the at least one optical element is at least one of a lens, a filter, a beam interrupter, a mirror, and an electro-optical element.

9. The device according to claim 1, wherein the support is drum-shaped and comprises optical elements along its circumference, wherein said optical elements can be placed individually, pairwise or groupwise in the observation beam path by rotating said drum-shaped support.

10. The device according to claim 1, wherein the support is wheel-shaped comprising at least one wheel with optical elements arranged in said wheel, wherein said optical elements can be placed individually or pairwise in the observation beam path.

11. The device according to claim 9, wherein at least two optical elements interact in a Galilei telescope fashion implementing different magnifications depending on the working position.

12. The device according to claim 10, wherein at least two optical elements interact in a Galilei telescope fashion implementing different magnifications depending on the working position.

13. The device according to claim 1, wherein said device is adapted to change the optical elements in a first and a second stereoscopic observation beam path.

14. A light microscope, comprising the device according to claim 1 for placing at least one optical element in an observation beam path of said light microscope.

15. The light microscope according to claim 14, wherein the microscope is a stereomicroscope.

16. The light microscope according to claim 14, wherein the microscope is a surgical microscope.

17. Light microscope according to claim 14, wherein said device is designed as a magnification changer for switching between discrete magnification levels.

18. The device according to claim 1, wherein said light microscope is a stereomicroscope.

19. The device according to claim 1, wherein said light microscope is a surgical microscope.
